(19) United States
(12) Patent Application Publication
(10) Pub. No.: US 2019/0099329 A1
(43) Pub. Date: Apr. 4, 2019

(54) AN APPARATUS FOR PRODUCING MICROSPHERES OF CUSTOMIZABLE SIZES EFFICIENTLY

(71) Applicants: Shanghai Tofflon Science and Technology Co., Ltd., Shanghai (CN); SHANGHAI JIAO TONG UNIVERSITY, Shanghai (CN)

(72) Inventors: Tuo Jin, Shanghai (CN); Baisong Guo, Shanghai (CN); Xiaodong Zheng, Shanghai (CN); Di Liu, Shanghai (CN)

(73) Assignees: Shanghai Tofflon Science and Technology Co., Ltd., Shanghai (CN); SHANGHAI JIAO TONG UNIVERSITY, Shanghai (CN)

(21) Appl. No.: 16/086,366

(22) PCT Filed: Apr. 19, 2017
(86) PCT No.: PCT/CN2017/081119

§ 371 Date: Sep. 19, 2018

(30) Foreign Application Priority Data
Apr. 25, 2016 (CN) 201610260675.9

(51) Int. Cl. A61J 3/06; B01D 63/16; B01D 63/06; B01D 69/10; B25J 21/02; B01L 3/00; B01L 7/04

(52) U.S. Cl. CPC A61J 3/06; B01D 63/16; B01D 63/062; B01D 69/10; B25J 21/02; B01L 3/52; B01L 7/525; B01D 2311/2642; B01D 2313/12; B01D 2313/22; B01D 2313/90; B01D 2325/02; B01L 7/04

(57) ABSTRACT

The present invention teaches a design of apparatus using which microspheres of customizable uni-sizes may be produced through a greatly simplified process. The apparatus consists a microsphere-forming unit, a microsphere rinsing unit, and a sterile hood that isolate the other two unit within a sterilized cover. The microsphere-forming unit enables the processed of microsphere formation, solidification and collection simultaneously. The sterile hood allow the microsphere producing operation be carried out within a glove box, preventing direct contact of operator with the sterilized materials of the microspheres. The apparatus has also a refrigerator wherein the microsphere collector and final product storage are placed for extracting the solvent of microsphere-forming materials and stabilizing the final product, respectively.

### CROSS REFERENCES AND RELATED APPLICATIONS

This application is a U.S. National Stage entry under 35 U.S.C. § 371 based on International Application No.: PCT/CN2017/081119, filed on Apr. 19, 2017, which was published under PCT Article 21(2) and which claims priority to Chinese Patent Application No. 201610260675.9, filed on Apr. 25, 2016, which are all hereby incorporated herein in their entirety by reference.

### TECHNICAL FIELD

This invention teaches a design of an apparatus for efficient production of micropsheres of customizable uniform sizes for pharmaceutical, biotechnological, food industrial and agricultural applications.

### BACKGROUND

Microspheres are particulate material systems spherical in shape and 1˜250 m in diameter. Polymeric microspheres offer great benefits in applications due to their fluidity, injectable convenience, and the most importantly, prolonged efficacy, and have therefore been extensively studied in pharmaceutical sciences since 1970s. This has been proposed in Polymers for sustained release of proteins and other macromolecules written by R. Langer and J. Folkman in Nature (263: 793-800). Sustained-release microspheres are especially important for delivering biologic medicines due to their impermeability across tissue membranes for which hateful frequent injection remains as the only way of administration.

Since 1980s, the global market of recombinant protein drugs surge in the 14-16% annual rate and reached 50+% of all prescription drug market. Now, there are over 150 protein drugs commercially available, 9000 on the R&D pipelines, and some of developing products may reach the market places in next few years. In spite of such remarkable advances in biologic medicines, their administration is still limited to frequent injections. Decades of research efforts have yet to achieve a single successful product in field of advanced dosage forms of biologic drugs, comprising prolong-dosing and non-injection delivery. Even for sustained-release microspheres, a highly demanded but conceptually old dosage form, there are only 10 microsphere products for peptide and chemical small molecule drugs available in the market to date. Practical application of sustained-release microspheres as pharmaceutical dosage forms for protein drugs has encountered two major hurdles, complicated production engineering and lack of appropriate method to preserve the native conformation of proteins. The present invention is a part of the solutions addressing the issue of production engineering.

The criteria for an ideal microsphere production technology comprises customizable uniform size to reduce the needle size for injection (because the needle size is determined by the largest particle), 90%+ encapsulation efficiency for drugs, preservation of protein native states, sustained and complete drug release with minimal initial burst, and easiness for sterilized production. None of the microsphere technologies reported to date could meet all these criteria. For example, the textbooks taught double emulsion suffers from diversified microsphere diameters and low encapsulation efficiency water-soluble drugs (most of biologic medicines fall in this category). Moreover, this method causes protein denaturing and harmful immune responses due to contacting with the water-oil interface (conditions required by particle formation). While spry-drying, another textbook method, may avoid water-oil interfacial tension encountered in double emulsion, it associates with water-air interfacial tension for encapsulating biologic drugs, another hazardous condition causing protein denaturing. In addition, the method encounters high temperature for evaporating water, floppy morphology of the encapsulating materials that causing severe burst release, uneven particle sizes, as well as low production efficiency. The so-called phase-separation method may produce microspheres of even sizes and 90%+ encapsulation efficiency. However, a medium immiscible with both water and polymer-solvent, such as silicone oil, must be used, which raises an environment and safety issue because washing the oil away requires considerable amount of gasoline (hexane or pentane).

Some newly invented processes advanced the art of microsphere production, of which the so-called SPG membrane and micro fluidizing are two typical examples. For the SPG method, the microsphere-forming polymer solution is forced by nitrogen (or other gasses) pressure to pass a porous membrane of defined pore size (SPG membrane) into a receiving medium in the form of soft embryonic micropsheres of even diameter. However, the soft embryonic microspheres are basically droplets of the polymer solution that may fuse with each other to larger particles. Stirring of the embryonic microspheres to prevent from fusion may break the soft droplets, causing leaks of water-soluble drugs and denaturing of proteins (by exposing the macromolecules to water-oil interfaces). Micro fluidizing utilizes a one-by-one injection of the droplets of microsphere-forming polymer solution into a flowing medium, by which each embryonic microsphere is driven away immediately to a drying process. While this method may achieve even particle size, 90%+ encapsulation efficiency, and minimal exposure of proteins to water-oil interfaces, its production efficiency is too low to meet massive production in an industrial scale. Micro fluidizing may be a perfect technology to produce millimeter-spheres of even sizes.

To overcome the complicity and quality assurance problems of the microsphere production technologies reported to date, Jin placed a SPG membrane into a flowing or standing aqueous medium to solidify embryonic microspheres free of stirring and fusing (Patent application WO2016131363 A1). The embryonic microspheres formed and taken off from the SPG membrane are quickly moving away in the receiving medium for which collision and fusion between the droplets of the polymer solution are avoided. Moreover, the solvent of the polymer solution is extracted into the aqueous medium due to its limited but sensible solubility in the medium, and the embryonic microspheres are therefore solidified. The present invention has improved the microsphere production process invented by Jin by a detailed device design.

### SUMMARY

Various non-limiting embodiments of an apparatus for producing microspheres of customizable sizes efficiently are disclosed herein.

In a first non-limiting embodiment, the apparatus for producing microspheres includes, but is not limited to, a porous membrane through which a solution of the microsphere-forming materials can be squeezed to form spherical droplets. The apparatus further includes, but is not limited to, a column through which the spherical droplets are settled down to the bottom and hardened by solvent extraction. The apparatus further includes, but is not limited to, a microsphere collector in which the hardened microspheres are collected. The apparatus still further includes, but is not limited to, a post-treatment container wherein the collected hardened microspheres are post-treated for removing organic solvent and other additives.

### BRIEF DESCRIPTION OF THE DRAWINGS

FIG. 1 is a schematic view illustrating a non-limiting embodiment of an apparatus for producing microspheres using a simplified process made in accordance with the teachings disclosed herein;

FIG. 2 is a schematic view illustrating a non-limiting embodiment of a corrugated pipe made in accordance with the teachings disclosed herein;

FIG. 3 is a schematic view illustrating a non-limiting embodiment of a floating inlet made in accordance with the teachings disclosed herein;

FIGS. 4(a′) and (b′) are schematic views illustrating a non-limiting embodiment of a vibrator made in accordance with the teachings disclosed herein; and

FIG. 5 is a schematic view illustrating a non-limiting embodiment of a microsphere collector made in accordance with the teachings disclosed herein.

### DESCRIPTION OF THE INVENTION

### Overall Design

Although the process to produce microspheres of designable uniform sizes through porous membrane-aided emulsification and sedimentation-based solidification was proposed in patent application WO2016131363A1 previously, the process has to be achieved using an appropriate apparatus.

The apparatus of the present invention for producing microspheres, consisting a porous membrane through which a solution of the microsphere-forming materials can be squeezed to form spherical droplets, a column through which the spherical droplets settle down to the bottom and are hardened by solvent extraction, a microsphere collector in which the hardened microspheres are collected, and a post-treatment container wherein the collected hardened microspheres are post-treated for removing organic solvent and other additives.

In some instances, the apparatus consists a microsphere solidification column equipped with a SPG membrane and microsphere collecting container at the two ends, a post-formation treatment container that receive the solidified microspheres, and a sterilized hood or cover wherein the formulation components are incorporated.

As used herein, the porous membrane can be SPG membrane that is referred to as Shirasu Porous Glass membrane and it is a kind of porous glass film.

In many instances, the porous membrane was cylindrical and possesses nearly uniform pore sizes which may be selected between 5 μm and 80 μm in diameter.

In many instances, the SPG membrane has 10 mm outer diameter, 8 mm inner diameter, 20˜500 mm length and 0.1-19.6 μm aperture.

### Microsphere Forming Part

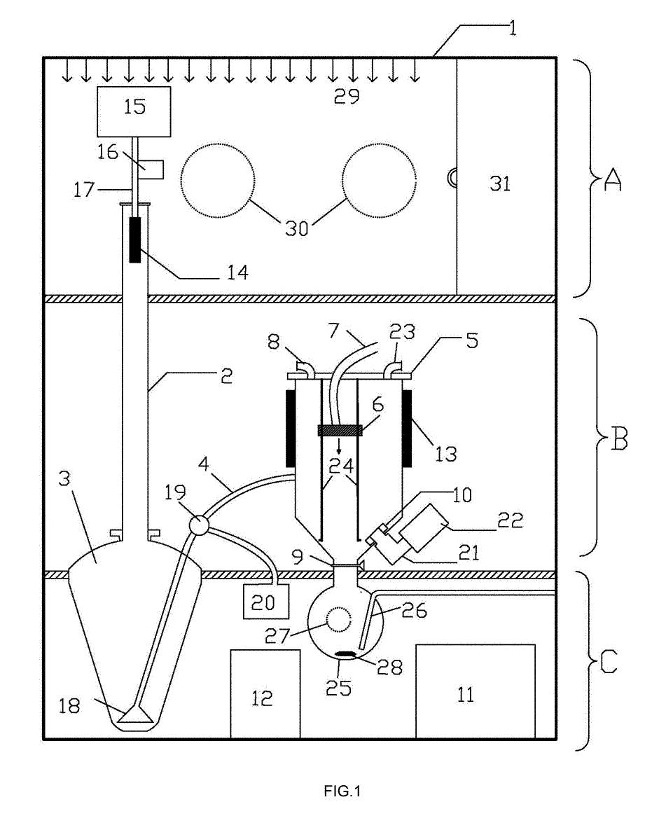

In many instances, the microsphere-forming part also comprises a tank (e.g. FIG. 1), 15˜500 mL in volume, for loading the microsphere-forming polymer (or other materials) solution and a holder (e.g. FIG. 1) of the cylindrical SPG membrane that is connected to the outlet of the tank of the polymer solution and inserts the SPG membrane in the receiving medium. The tank for loading the polymer solution has also an inlet for introducing pressured gas (not shown in FIG. 1). The holder is also a tube on which the porous membrane is mounted. The pressured gas to pass through the holder can therefore squeeze the solution of microsphere-forming materials such as polymer and the porous membrane to form spherical droplets and subside in the receiving medium called receiving medium along the sedimentation-based solidification column or tube to the microsphere collector (e.g. FIG. 1).

In many instances, the pressured gas can be nitrogen, carbon dioxide or other inert gases.

In many instances, the tank is also equipped with a material stirring device and pressure control device. The material stirring device is located in the tank to stir the material. The pressure control device can control the gas pressure.

### The Sedimentation-Based Solidification Column

The solution containing microsphere-forming materials and API pass though the holder and the porous membrane by the pressure gas to form soft spherical droplets, called as embryonic microspheres. The embryonic microspheres before solidifying are easily fusing with each other to become big particle, so a unit operation should be taken to prevent the fusion of embryonic microspheres in the present manufacturing process. Stirring as a normal operation could generate shear stress to reduce the fusion of the embryonic microspheres. However the shear stress also may break the newly formed embryonic microspheres and result in leaking of the ingredient to be capsulated.

A column 200˜2200 mm in length could provide a sufficient long path heading to a microsphere collector, through which the embryonic microspheres are settled down to the bottom and hardened by solvent extraction, named the sedimentation-based solidification column. As compared with stirring, which is avoiding of leaking of the ingredient to be encapsulated. To shorting the distance of microsphere sedimentation, temperature of the receiving continuous phase may be adjusted to increase solubility of the solvent or solvents with which the microsphere-forming materials are dissolved. For example, the water solubility of dichloromethane can increase from 2% to 5% when water temperature drops from 25° C. to 2° C., which could facilitate solvent extraction. Therefore, the bottom of sedimentation-based solidification column should be in refrigeration.

In many instances, the column is designed in a diameter selected between 40 mm and 160 mm to meet respective batch size of microsphere production,

The microsphere solidification column may be made of glass, quartz, Teflon, or stained steel.

In many instances, a sensor and a motor are equipped to control the liquid level of the sedimentation-based solidification column during transferring the solidified microspheres from the microsphere collector to the post-treatment container.

### The Vibrator

In many instances, a vibrator is mounted on the holder of the porous membrane to shake the microsphere-forming materials and to facilitate taking off of the polymer droplets squeezed out of the porous membrane, reducing the adhesion of the droplets on the membrane, which could produce great effects on the diameter distribution of embryonic microspheres and solidified microspheres. The vibrator may be pneumatic pushrod, electromotive pushrod, manual pushrod or any other reciprocator.

The vibration frequency is related to the pressured gas. In many instances, the frequency maybe adjusted within 1˜10 times/s, or 100˜500 times/min, with the best to be 200˜400 times/min. And the vibration amplitude maybe adjusted within 1 to 20 mm. Under the optimal vibration frequency and amplitude, the particle size of the microspheres is more uniform and the production efficiency is higher.

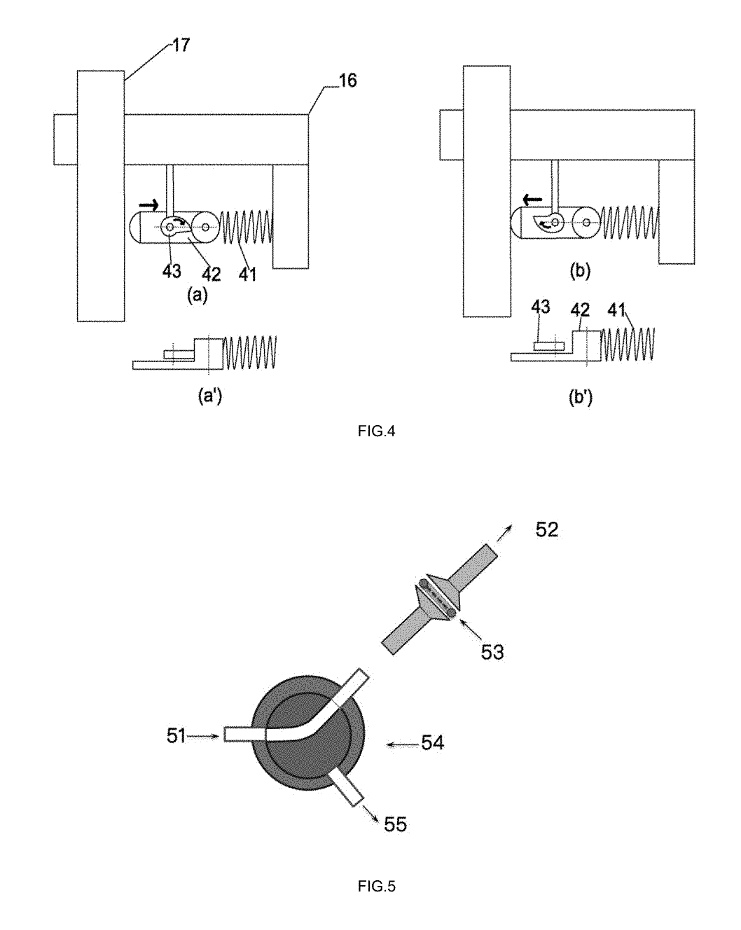

In some disclosed apparatus, a vibrator used is shown in FIG. 4.

As it shows, (a) Front view: the striking part 42 is pushed away from the holder 17 by the rotatable cam 43, (a′) Upward view of some part of the vibrator 16; (b) Front view: the striking part 42 is striking the holder 17 when the rotatable cam 43 turn around, (b′) Upward view of some part of the vibrator 16. In other instances, a cycloid gear can replace the cam. The use of cam or cycloid gear provides a discontinuity hit to the holder and therefore vibrating effect can be gained.

### Microsphere Collecting and Outputting

The microspheres hardened by solvent extraction through the long path column and settled in the bottom of the container, if it is vertical, should best be concentrated and output with minimal volume of the continuous/receiving phase. Minimizing the volume of the continuous phase is essential for improving the efficiency of rinsing the microspheres to remove the residues of the organic solvent in the matrix of microspheres and the excipients in the continuous phase.

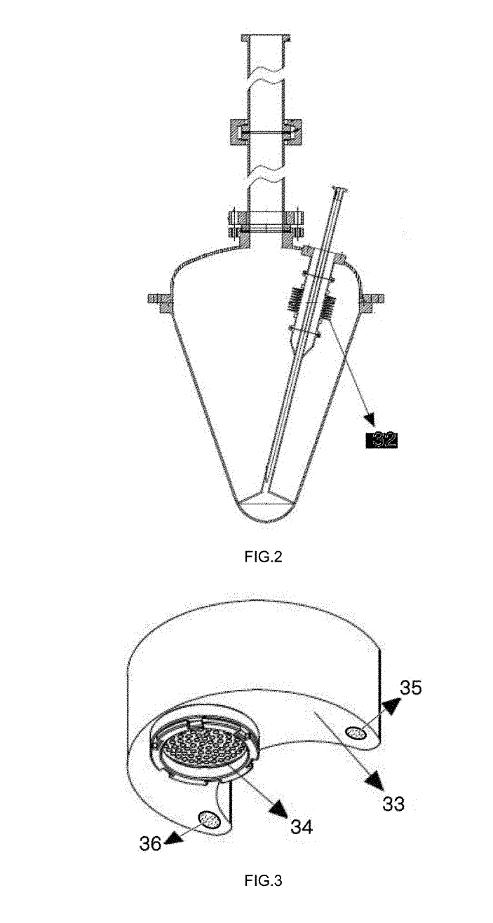

Design of the microsphere container for the continuous phase should facilitate the microsphere concentration. FIG. 2 shows, but not limits to, a design of the bottom of the container by which hardened microspheres may be accumulated and concentrated. The center of the container for collecting microspheres may be deepened to allow microspheres to slide in and accumulated. The deepened part may be cylindrical, rounded, or cone shape (e.g. FIG. 2). In some instances, the end of the bottom of the container should also be flat when pipe socket method is used in order to minimize the dead volume for transferring the solidified microspheres.

The microsphere collector may be made of glass, quartz, stainless steel or Teflon and connected to the microsphere-solidifying column.

The microsphere collector may be 500 mL to 5000 mL in volume.

### Transferring Microspheres to Post-Solidification Treatment

Output of the accumulated microspheres may be achieved via various methods. There are two output designs, draining the accumulated microspheres from the bottom, or socking them up through a pipe socket. The pipe socket has a bell-shaped or cone-shaped entrance (e.g. FIG. 1). Another alternative may be that the hardened microspheres are output along the tangent of a flat bottom of the container of the continuous phase by pumping. One key setup mechanism is that the gap between the bell- or cone-shape entrance and the bottom of the container should be small enough to create a sufficient velocity of the receiving liquid at a reasonable flow, by which the microspheres can be carried away. The gap should be optimized between 1 and 20 mm, with the most appropriate range between 3 and 10 mm, depends on production volume.

In some instances, a tube for transferring microspheres from the microspheres container to the next post-formation treatment can adjust its angle and length back and forth. The tube is also equipped with a pump and a kind of corrugated pipe is mounted around it. (e.g. FIG. 2). The pump maybe a creeping pump or an electromagnetic pump, which can pumping the microspheres from the microspheres container out. This pump can also be connected with the rinsing/post-treatment container.

### N-Line Quality Control

For efficient production, an inline quality control setup to eliminate oversized microspheres will be the ideal design. In this invention, such a quality control unit is placed between the two unit operations, 1) microsphere forming, solidifying, and collecting; and 2) microsphere smoothing, solvent removal, and rinsing. This quality control unit possesses two functions, block oversized microspheres selectively and eject oversized microspheres out of the production line.

For the former, a mesh screen is mounted in the tube connecting the microsphere collector to the microsphere post-formation treatment container; while for the later, a three-way valve mounted behind the mesh screen. The three-way valve connects three units, 1) the microsphere collector, 2) the post-treatment container and 3) a disposal container. By opening the path from 1) to 2), microsphere production is proceeding; by opening the path from 1) to 3), the contents in the microsphere solidification column and the collector can be drained out; by opening the path from 2) to 3), the oversized microspheres intercepted by the mesh screen 53 can be discharged. The quality control unit is schematically described in FIG. 5. For efficient drainage and discharge, the position of the three-way valve should be as lower as possible, but above of the refrigeration compartment.

### Post-Formation Treatment

In some instances, the container (rinsing or post-treatment container) for post-formation treatment/rinsing of the microspheres is connected with the microsphere collector through a tube, which equipped with a valve and a creeping or an electromagnetic pump.

In the rinsing/post-treatment container, a stirring impellor is mounted around a sealed hollow shaft, and a magnetic rotor is mounted inside this hollow shaft and driven by an electric reducer that connected with a motor outside the container (e.g. FIG. 1). In some instances, the reducer is preferably a vertical reducer that can lower the rinsing/post-treatment container. The stirring impellor maybe made of corrosion resistant material, like polytetrafluoroethene.

This kind of stirring design is more conducive to adjust production and improve production efficiency, and avoid sample contamination.

In some instances, the magnetic rotor's rotating speed maybe adjusted within 50˜300 r/min, and maybe adjusted within 100˜200 r/min for better.

To avoid re-stirring the settled microspheres, drainage of the supernatant should best be accomplished by pumping from the top of the rinsing medium or other microsphere treating solvent, like washing water. For this purpose, a floating inlet (e.g. FIG. 1 and FIG. 3) is used for the top water pumping.

The floating inlet can drain the rinsing medium from the top of the liquid for which the microspheres continues their settlement to the bottom of the container during disposal of the medium. The entrance of the pumping inlet (floating inlet) should be large enough to lower the velocity of the draining, and may be covered by a mesh screen (or filtrating membrane) to prevent microspheres from being pumped or drained. In some instances, material transfer pump and outlet is mounted on the cap of the container.

As the floating inlet moves around with the liquid medium irregularly in the container, it may affect the stirring impellor's work. A guide-positioning device should be equipped in the container to guide the floating inlet move. In some instances, two guide positioning lines that mounted on the cap of the container were used. The floating inlet have two through-holes to let the guide positioning lines pass through and can make itself move up and down along with the guide positioning lines without disturb the stirring impellor.

In some instances, the cross section of the floating inlet may be, but not limits to, a half crescent shaped (e.g. FIG. 3) or circular. The shape is required to be designed not to interfere with stirring.

In some instances, the bottom of the floating inlet has a screen mesh or a filtrating membrane 34 (e.g. FIG. 3). The screen mesh may be made of quartz, stainless steel or Teflon. The filtrating membrane may be corrosion resistant polymer filtration membrane, like the polyethersulfone ultrafiltration membrane (PES membrane). The screen mesh or filtrating membrane area is smaller than the bottom area of the floating inlet, and may be circular in shape with 3-30 cm in diameter. The height of floating inlet cannot be too high and can be set to 1-10 cm.

The pore size of the screen mesh or filtrating membrane is related to the particle size of the hardened microspheres. In some instances, the pore size is smaller than the particle size of the microsphere product, thereby avoiding the drained of the microsphere product out. The pore size may be less than 10 μm.

In some instances, the post-treatment container consists of two parts, including the cylinder shape of the upper part and the inverted cone shape of the lower part. The stirring impellor is mounted on the medial side of the inverted cone lower part. The floating inlet can fall down from the cylinder upper part to the bottom of the other side of the inverted cone part that close to the microspheres blew. This design has better washing or rinsing efficiency.

The container has a gate valve blew to unload the rinsed and post-formation treated microspheres to a container for final product storage. The container for post treatment may be wrapped with a heating jacket for thermo-annealing of the solidified microspheres. This heating jacket can be mounted around the post-treatment container for temperature-assistant microsphere smoothing and solvent diffusion.

### The Sterile Hood (or Cover)

The unit for microsphere formation, solidification and collection and the unit for post-formation treatment of the solidified microspheres are placed within a hood, which consists three compartments. The top is a sterilized glove box (e.g. FIG. 1: A) wherein the operations of weighting the microsphere-forming materials, preparing the polymer solution, and loading the polymer solution into the tank can be carried out. Above the glove box is a device to create laminar flow of sterilized air. Below the glove box is a storage and post-treatment compartment (e.g. FIG. 1: B) wherein the container for post-formation treatment of the microspheres is placed.

Additional microsphere receiving medium is also stored in this compartment for continuous microsphere production. For more extended continuous microsphere production, connectors to introduce the receiving medium from outside are equipped in this compartment instead. At the bottom of this apparatus is a refrigeration compartment (e.g. FIG. 1: C) in which the microsphere collector is placed. The temperature in this compartment will be maintained at 0˜8° C. or 0˜4° C. The microsphere sedimentation-based solidification column or tube is runs through all these three compartments from the top glove box A to the bottom refrigerator C.

A container for storing the microspheres experienced all the formation and treatment steps is also place in the refrigeration compartment. This container is named as final product storage container (e.g. FIG. 1). This container is connected with the post-treatment through a gate valve. The final product storage container possesses a rubber-stopped window 27 (e.g. FIG. 1) for taking samples to quality assessment without rupturing the sterilized condition. The final product storage container has also an outlet for outputting the quality-assessed microspheres for lyophilization under a sterilized condition. The refrigeration compartment may have a transparent door/window for visualizing the microspheres in the collector and final product container. The refrigeration compartment may also have a control panel 12 outside that equipped with an operating system for adjusting the power switch, working temperature, gas pressure or/and stirring speed.

The invention overcomes the defects of the prior art, the microsphere preparation process molding, solidifying, collecting, rinsing and sieving operations of five units in the implementation of an apparatus, so the whole process can be placed in sterile isolators, the simplified production process is environmentally friendly, safe, and offers greatly improved product quality.

This invention discloses the design/structure of apparatus for producing microspheres of customizable uniform sizes, 90+% encapsulation efficiency, and preserved native conformation of protein drugs using a simplified process. As an essential improvement, this apparatus ensures operation of the simplified microsphere production process invented recently. The patent application no. Is WO2016131363 A1. One of the design of this apparatus is also described schematically in FIG. 1.

### DESCRIPTION OF THE DRAWINGS

The present invention will hereinafter be described in conjunction with the following drawing figures, wherein like numerals denote like elements, and: FIG. 1 Design of the apparatus for producing microspheres using a simplified process.

The parts of the microsphere producing apparatus are: A. Sterilized glove box; B. Storage and post-treatment compartment; C. Refrigeration compartment.

1. Sterile hood/cover; 2. The sedimentation-based solidification column; 3. Microsphere collector; 4. Tube for transferring microspheres; 5. Rinsing/post-treatment container; 6. Floating inlet; 7. Drainage outlet with a material transfer pump ; 8. Inlet for feeding rinsing medium; 9. Gate valve for unloading microspheres; 10. Stirring impellor; 11. Refrigeration unit ; 12. Control panel ; 13. Heating jacket; 14. SPG membrane; 15. Tank; 16. Vibrator; 17. Holder; 18. Cone-shaped pipe socket ; 19. Three-way valve; 20. Disposal container; 21. Electric reducer; 22. Motor; 23. Outlet connecting vacuum pump; 24. Guide positioning lines; 25. Final product storage container; 26. Tube for transferring microspheres to final outlet; 27. Rubber-stopped window; 28. Magnetic stirring bar; 29. Flow of sterilized air; 30. Glove windows; 31. Transfer or store materials cabinet.

FIG. 2 Design of the microsphere collector

32. Corrugated pipe.

FIG. 3 Design of a floating inlet for draining microsphere rinsing medium from the top of the liquid.

33. Body of floating inlet; 34. Screen mesh or filtrating membrane; 35, 36. Two through-holes.

FIG. 4 Design of a vibrator.

16. Vibrator; 17. Holder; 41. Spring; 42. Striking part ; 43. Rotatable cam.

(a) Front view: the striking part is pushed away from the holder by the rotatable cam, (a′) Upward view of some part of the vibrator; (b) Front view: the striking part is striking the holder when the rotatable cam turn around, (b′) Upward view of some part of the vibrator. In other instances, a cycloid gear can replace the cam.

FIG. 5 Design of a quality control unit that discriminates and ejects oversized microspheres, comprising a mesh screen and a three-way valve.

51. From microsphere collector; 52. To rinsing container; 53. Mesh screen; 54. Three way valve; 55. Drainage to disposal container.

### EXAMPLES

The example below is part of our on-going research of similar apparatus and for helping readers to comprehend the invention better. The examples should not be used to limit applications of the present invention.

As shown in FIG. 1, the apparatus consisting a SPG membrane 14 through which a solution of the microsphere-forming materials can be squeezed by pressured gas to form spherical droplets, a sedimentation-based solidification column 2 through which the spherical droplets are settled down to the bottom and hardened by solvent extraction, a microsphere collector 3 in which the hardened microspheres are collected, and a post-treatment container 5 wherein the collected hardened microspheres are post-treated for removing organic solvent and other additives.

A tank 15 loading the microsphere-forming materials connect with a tube that is also a holder 17. The SPG membrane 14 and a vibrator 16 are mounted on the holder 17. The SPG membrane 14 inserts in the sedimentation-based solidification column 2 and immersed in the receiving medium. The receiving medium fills along the sedimentation-based solidification column 2 to the microsphere collector 3.

The microsphere collector 3 has a cone shape with a flat bottom, and equipped with an inner tube 4 to pump the collected microspheres to the post-treatment container 5. The tube 4 can adjust its angle and length back and forth. The tube 4 has a cone-shaped entrance 18 and a pump that can transfer the hardened microspheres to the later post-formation 5. A mesh screen 53 is mounted in the tube 4 connecting the microsphere collector to the microsphere post-formation treatment container; while for the later, a three-way valve 19 mounted behind the mesh screen 53.

The post-treatment container 5 has an inlet at its side connected to the microsphere collector 3, an outlet at its bottom connected to a container 25 for final product storage. The post-treatment container 5 has a stirring impellor 10 that is mounted around a sealed hollow shaft at the bottom of the post-treatment container, and a magnetic rotor is mounted inside this hollow shaft. The magnetic rotor is driven by an electric reducer 21 which connected with a motor 22 outside the container; the magnetic rotor's rotating speed maybe adjusted within 50˜300 r/min.

As shown in FIG. 1 and FIG. 3, the post-treatment container has a floating inlet 6 connecting the drainage outlet 7 for draining the microsphere rinsing medium form the top of the liquid, and a mesh screen 34 to prevent microspheres from being drained may cover the entrance of the floating inlet. The mesh screen 34 is circular in shape with 10-25 cm in diameter. The pore size of the mesh screen is less than 10 μm.

Two guide positioning lines 24 that mounted on the cap of the container were used. The floating inlet 6 have two through-holes 35, 36 to let the guide positioning lines 24 pass through and can make itself move up and down along with the guide positioning lines 6 without disturb the stirring impellor 10 in the post-treatment container 5.

The functional components such as the porous membrane 14, column 2, microsphere collector and post-treatment container 5 are incorporated within a sterilized hood 1. A sterilized glove box ‘A’ at the top wherein the microsphere forming materials are loaded for being pressed through the porous membrane; a cabinet ‘B’ under the glove box ‘A’ wherein the post-treatment container 5 is located; and a refrigeration compartment ‘C’ at the bottom wherein the microsphere collector 3 is located; the column 2 is runs through all these three compartments from the top glove box to the bottom refrigeration compartment.

A heating jacket 13 is mounted around the post-treatment container 5 for temperature-assistant microsphere smoothing and solvent diffusion. The post-treatment container 5 has a gate valve 9 at the bottom for unloading the rinsed and post-formation treated microspheres to a container 25 for final product storage. The container 25 has a magnetic stirring bar 28 and a rubber-stopped window 27 (e.g. FIG. 1) for taking samples to quality assessment without rupturing the sterilized condition. The container 25 also has a tube 26 for transferring microspheres to final outlet. The refrigeration compartment has a control panel 12 outside that equipped with an operating system for the power switch, working temperature, gas pressure or/and stirring speed. The refrigeration unit 11 set in the refrigeration compartment ‘C’ to provide refrigeration environment. There is a cabinet 31 for transferring or storing materials that include microsphere-forming polymer. The cabinet 31 can be opened inside the glove box through gloves. The flow of sterile air 29 continuously transported into the apparatus to keep it sterile.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. An apparatus for producing microspheres, the apparatus comprising:
a porous membrane through which a solution of the microsphere-forming materials can be squeezed to form spherical droplets;
a column through which the spherical droplets are settled down to the bottom and hardened by solvent extraction;
a microsphere collector in which the hardened microspheres are collected; and
a post-treatment container,
wherein the collected hardened microspheres are post-treated for removing organic solvent and other additives.

2. The apparatus of claim 1, wherein the porous membrane was cylindrical and possesses nearly uniform pore sizes which may be selected between 5 μm and 80 μm in diameter; wherein the column is designed in a diameter selected between 40 mm and 160 mm to meet respective batch size of microsphere production, and its length ranges from 200 mm to 2200 mm.

3. The porous membrane of claim 2 is mounted on a holder, and the holder is a tube that can transfer the squeezed microsphere-forming materials to the porous membrane.

4. The apparatus of claim 3, wherein a vibrator is mounted on the holder to shake the microsphere-forming materials and to facilitate taking off of the spherical droplets squeezed out of the porous membrane, and the vibration frequency maybe adjusted within 1˜10 times/s; the vibrator may be pneumatic pushrod, electromotive pushrod, manual pushrod or any other reciprocator.

5. The apparatus of claim 1, wherein a sensor and a motor are equipped to control the liquid level of the column during transferring the hardened microspheres from the microsphere collector to the post-treatment container.

6. The microsphere collector of claim 1 is in cylindrical, rounded, or cone shape with a flat bottom, and equipped with an inner tube to pump the collected microspheres to the post-treatment container.

7. The apparatus of claim 1, wherein a tube for transferring microspheres from the microspheres container to the next post-formation treatment is equipped with a pump which can transfer the hardened microspheres to the later; the tube can adjust its angle and length back and forth, and a corrugated pipe is mounted around it; the pump is a creeping pump or an electromagnetic pump.

8. The apparatus of claim 1, wherein a mesh screen is mounted in the tube connecting the microsphere collector to the microsphere post-formation treatment container; while for the later, a three-way valve mounted behind the mesh screen.

9. The post-treatment container of claim 1 has an inlet at its side connected to the microsphere collector, an outlet at its bottom or side connected to a container for final product storage, and a drainage outlet mounted on its cap for draining the microsphere treating solvent from the top of the liquid.

10. The apparatus of claim 1, wherein post-treatment container has a stirring impellor that is mounted around a sealed hollow shaft at the bottom of the post-treatment container, and a magnetic rotor is mounted inside this hollow shaft.

11. The apparatus of claim 10, wherein the magnetic rotor is driven by an electric reducer which connected with a motor outside the container; the magnetic rotor's rotating speed maybe adjusted within 50˜300 r/min.

12. The apparatus of claim 1, wherein post-treatment container has a floating inlet for draining the microsphere rinsing medium form the top of the liquid; and a mesh screen to prevent microspheres from being drained may cover the entrance of the floating inlet.

13. The apparatus of claim 9, wherein post-treatment container has a floating inlet connecting the drainage outlet for draining the microsphere rinsing medium form the top of the liquid,

14. The apparatus of claim 12, wherein a guide-positioning device is equipped in the container to guide the floating inlet move, and the cross section of the floating inlet may be a half crescent shaped or circular.

15. The apparatus of claim 1, wherein the functional components such as the porous membrane, column, microsphere collector and post-treatment container are incorporated within a sterilized hood.

16. The sterilized hood of claim 15 consists three compartments, a sterilized glove box at the top wherein the microsphere forming materials are loaded for being pressed through the porous membrane; a cabinet under the glove box wherein the post-treatment container is located; and a refrigeration compartment at the bottom wherein the microsphere collector is located; the column is runs through all these three compartments from the top glove box to the bottom efrigeration compartment.

17. The apparatus of claim 1, wherein the column is made of stainless steel, glass, Teflon, quartz or a composite from them; wherein the microsphere collector is made of stainless steel, glass, Teflon, quartz or a composite from them; wherein the post-treatment container is made of stainless steel, glass, Teflon, quartz or a composite from them.

18. The apparatus of claim 1, wherein a heating jacket is mounted around the post-treatment container for temperature-assistant microsphere smoothing and solvent diffusion.

19. The apparatus of claim 1, wherein the post-treatment container has a gate valve at the bottom for unloading the rinsed and post-formation treated microspheres to a container for final product storage.

20. The apparatus of claim 16, wherein the refrigeration compartment has a control panel outside that equipped with an operating system for the power switch, working temperature, gas pressure or/and stirring speed.
